(19) United States
(12) Patent Application Publication
(10) Pub. No.: US 2006/0067878 A1
(43) Pub. Date: Mar. 30, 2006

(54) Metal alanates doped with oxygen

(76) Inventors: Xia Tang, West Hartford, CT (US); Donald L. Anton, Tolland, CT (US); Susanne M. Opalka, Glastonbury, CT (US)

Correspondence Address: CARLSON, GASKEY & OLDS, P.C., 400 WEST MAPLE ROAD, SUITE 350, BIRMINGHAM, MI, 48009, US

(21) Appl. No.: 10/951,011

(22) Filed: Sep. 27, 2004

(51) Int. Cl. C01B 6/24; H01M 8/06

(52) U.S. Cl. 423/644; 429/19

(57) ABSTRACT

A metal alanate material useful for reversible hydrogen storage as in fuel cell applications includes a metal alanate material that is doped with oxygen. In discussed examples, the metal alanate material is one of an alkali metal alanate or mixed alkali metal-alkaline earth metal alanate. In some examples, the oxygen is doped into the metal alanate from an unstable solid oxide having −ΔG_{f}⁰<200 Kcal/mole or from a hydroxide, a carbonate, a nitrate or an oxygen gas mixture. The metal alanate in one example is doped with between 0.5 mol % and 30 mol % oxygen.

### BACKGROUND OF THE INVENTION

This invention relates to reversible hydrogen storage material. More particularly, this invention relates to a metal alanate material that is doped with oxygen, thereby allowing increased hydrogen absorption kinetics and storage capacity compared to previously known doped metal alanate materials.

Metal alanates, such as NaAlH₄, are generally known as reversible hydrogen storage materials. A metal alanate stores and releases hydrogen, and can be replenished with hydrogen at moderate pressures and temperatures. At approximately 80° C. dehydrogenation (i.e., liberation of hydrogen) of the metal alanate is thermodynamically favorable. In a reverse rehydrogenation reaction at 100°-120° C. and 60-100 bar, hydrogen is recharged back into the metal alanate. Fuel cell devices, for example, can utilize metal alanates because of these relatively temperate dehydrogenation and hydrogenation conditions.

In applications such as a fuel cell device, greater volumetric hydrogen storage capacity is desirable. In an effort to increase the hydrogen storage capacity of conventional metal alanates, it has been proposed to add dopant amounts of certain transition metals as thermodynamic catalysts. Typically, doping with approximately 2-6 mol % of the transition metal, such as Sc, Ti, or Zr, significantly increases the hydrogen absorption and desorption kinetics.

A drawback of using conventional transition metal dopants is the diminishing, or negative, effectiveness of the dopants in amounts over 2 mol %. For instance, the hydrogen absorption of NaAlH₄ decreases substantially when the amount of a Sc dopant increases from 2.0 mol % to 3.3 mol %. The limit of effectiveness of a Sc dopant is 2.0 mol %. Ti has been effectively used as a catalyst in NaAlH₄ up to 6 mol % concentrations. These higher levels of dopant come at the cost of increased halide content, which forms NaCl or NaF thus reducing overall capacity. Increasing catalyst content over 4 mol % is thus undesirable.

A metal alanate material that provides increased hydrogen storage capacity beyond that which is available from the limited effectiveness of conventional dopants is needed. Mechanical milling of NaAlH₄ with some oxides such as Al₂O₃ and CeO₂ have been noted in the literature with only slight enhancement of kinetics. Utilizing oxides with −ΔG_{f}⁰>200 Kcal/mole such as Al₂O₃ and CeO₂ does not lead to incorporation of the oxygen into the system and thus limited kinetic activity.

### SUMMARY OF THE INVENTION

In general terms, this invention is a metal alanate material used for reversible storage of hydrogen as in fuel cell applications.

In one example, the metal alanate base material is one of an alkali metal alanate or a mixed alkali metal-alkaline earth metal alanate. The base metal alanate material is doped with approximately 0.5%-30% oxygen (on a molecular basis) to thereby enhance the hydrogen storage kinetics and capacity of the material.

In one example, the source of dopant oxygen is a solid oxide. The solid oxide is selected from a group of unstable solid oxides, those with a −ΔG_{f}⁰>200 Kcal/mole, including Cu₂O, NiO, PdO, SeO₂, ZnO, for example.

In one example, the solid oxide is doped into the metal alanate using a known ball-milling technique. Alternatively, the oxygen may be introduced to the metal alanate by a gas mixture including oxygen gas and an inert gas.

A metal alanate doped with oxygen allows the dopants, such as Sc, to be used in amounts that exceed the previous limitation of effectiveness of 2 mol %. Metal alanates doped with oxygen provide an improved reversible hydrogen storage material and exhibit favorable kinetic and thermodynamic characteristics required for use in fuel cell devices, for example.

The various features and advantages of this invention will become apparent to those skilled in the art from the following detailed description of the currently preferred embodiments. The drawings that accompany the detailed description can be briefly described as follows.

### BRIEF DESCRIPTION OF THE DRAWINGS

FIG. 1 is a general schematic view of an automobile having a fuel cell device with a hydrogen storage portion designed according to this invention; and

FIG. 2 graphically shows example hydrogenation results using an example metal alanate material designed according to the invention.

### DETAILED DESCRIPTION OF THE PREFFERRED EMBODIMENT

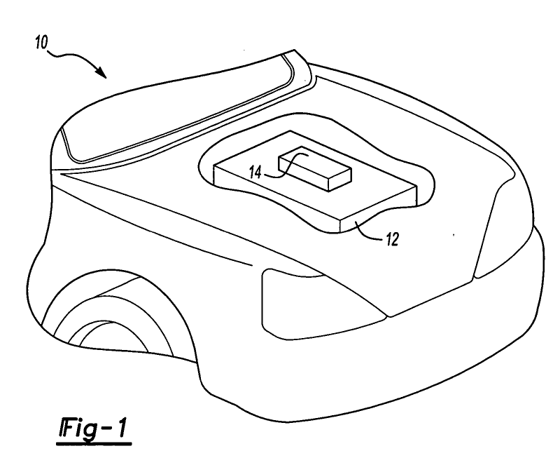

FIG. 1 schematically shows an automobile 10 utilizing a fuel cell device 12 for power. In generating power, the fuel cell device 12 requires hydrogen, and therefore an on-board source of storing the hydrogen. A hydrogen storage portion 14 of the fuel cell device 12 includes a metal alanate material that is doped with oxygen.

The base material of the metal alanate material can be an alkali metal alanate, a mixed alkali metal-alkaline earth metal alanate or a transition metal alanate. The alkali metal alanate in one example preferably is NaAlH₄ and the mixed alkali metal-alkaline earth metal alanate preferably is described by the formula:
M¹₍₁₋ₓ₎M²ₓ(AlH₄)ₓ₊₁
where M¹ is an alkali metal; M² is an alkaline earth metal; and 0≦x≦1. Alternatively, a transition metal alanate could be used such as Tm⁺ⁱ (AlH₄)ᵢ where Tm is a transition metal having a valence state, i. Alternatively a mixed Alkaline metal, alkaline earth metal and transition metal such as
Mx¹My²Tmⁱ_{(l-x-y)}(AlH₄)_{x+2y+i-ix-iy}
where M¹ is an alkali metal, M² is an alkaline earth metal, Tm is a transition metal having a valence state, i, x+y=1, and O≦x, y≦1. One skilled in the art who has the benefit of this description would recognize additional suitable base metal alanate materials that would be useful for making a material according to this invention.

As is known in the art, base metal alanate materials may be doped with approximately 2 mol % of certain transition metals to enhance the hydrogenation thermodynamics. A dopant, such as Sc, can be added to a base metal alanate material via any number of methods known in the art. Sc in particular has a superior catalytic effect compared to some other common dopants. For example, the rehydrogenation rate of NaAlH₄ using a Ti catalyst added in the form of TiCl₂ yields a rehydrogenation rate of less than 0.36 wt %/hr under conditions of 100° C. and 60 bar. Under the same conditions, NaAlH₄ using Sc added in the form of ScCl₃ yields a rehydrogenation rate of 1.03 wt %/hr.

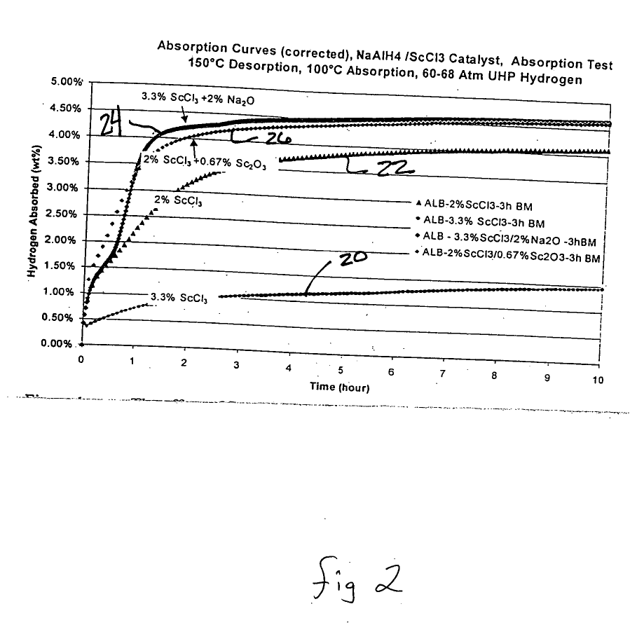

Referring to FIG. 2, the addition of Sc in amounts exceeding 2 mol % substantially reduces the hydrogen storage capacity of the metal alanate material. Under hydrogenation conditions of 100° C. and 60-68 atm ultra high purity, UHP, hydrogen, NaAlH₄ doped with 3.3 mol % Sc added in the form of ScCl₃ shows a total hydrogen storage capacity of approximately 1.5 wt % after 10 hours. This is shown by the curve 20. Under the same conditions, NaAlH₄ doped with 2.0 mol % Sc added in the form of ScCl₃ yields a total hydrogen storage capacity of 4.00-4.50 wt % after 10 hours. This is shown by the curve 22. Accordingly, any additional Sc catalyst over 2.0 mol % has a negative effect on hydrogen storage capacity.

The decreased hydrogen storage capacity in metal alanates with Sc levels exceeding 2 mol % is more than expected due to the weight of the catalyst itself.

For a fixed volume of metal alanate, a catalyst displaces a portion of the hydrogen storing base metal alanate material. Consequently, the use of a catalyst involves competing interests; the beneficial catalytic effect versus reduced hydrogen capacity from displaced base metal alanate. One skilled in the art can calculate the expected loss in hydrogen storage capacity due to the catalyst displacing the base metal alanate.

When increasing the amount of Sc catalyst from 2.0 mol % to 3.3 mol %, there is an expected loss of hydrogen storage capacity due to the catalyst displacing the base metal alanate. The actual loss of hydrogen storage capacity is greater than the expected loss. Therefore, the Sc must also be acting as a thermodynamic inhibitor to the base metal alanate. This is mainly due to an increase in equilibrium pressure from the “excess” Sc dopant.

With this invention, increased performance is possible, and the decreasing effectiveness of increased metal dopants is avoided.

In one example metal alanate material, approximately 0.5 mol %-30 mol % of dopant oxygen lowers the equilibrium pressure associated with the Sc dopant. The dopant oxygen lowers the equilibrium pressure and allows a Sc dopant to be added at levels exceeding the previously effective limits (i.e., 2 mol %). In some examples, the Sc dopant may be added at levels up to approximately 25 mol %. The dopant oxygen counteracts the increase in equilibrium pressure associated with the increased Sc dopant (i.e., an amount over 2 mol %) and yields favorable hydrogenation characteristics.

Referring to curve 20 in FIG. 2 for example, the hydrogen storage capacity of NaAlH₄ with a Sc dopant added in the form of ScCl₃ at 3.3 mol % is approximately 1.50%. The storage capacity of NaAlH₄ with the same amount of Sc dopant added in the form of ScCl₃ and dopant oxygen added in the form of Na₂O, however, is 4.50-5.00%. This is shown by curve 24. The dopant oxygen counteracted the increased equilibrium pressure associated with the Sc catalyst. Similar results follow for catalysts other than Sc.

Improved results are available even when using the previously believed optimum Sc dopant amount. The curve 26 shows that adding 0.67 mol % Sc₂O₃ in addition to 2 mol % ScCl₃ increases the absorbed hydrogen to more than 4.5 wt %, compared to just over 4.0 wt % absorbed hydrogen for 2 mol % ScCl₃ shown by curve 22. In this example an additional 0.5 wt % absorption becomes possible because of the added oxygen dopant.

Several different known methods may be used to dope a base metal alanate material with oxygen. In one example high energy ball-milling is one preferred method, using solid oxides or hydroxides as the oxygen source.

The preferred solid oxide oxygen sources include an unstable oxide, such as those having −ΔG⁰_{f}>200 kcal/mol. For example, BaO₂, BeO, Bi₂O₃, CdO, Cu₂O, Au₂O₃, IrO₂, Li₂O, Hg₂O, NiO, Tl₂O, SeO₂, ZnO, TeO₂, Ag₂O, PuO₂, PdO, Na₂O and ZnO, are effective oxygen sources when ball-milling is the selected doping technique. Example suitable nitrates include AgNO₃, CdNO₃, Co(NO₃)₂, CsNO₃, Cu(NO₃)₂, Fe(NO₃)₂, KNO₃, LiNO₃, NaNO₃, NH₄NO₃, Ni(NO₃)₂, Pb(NO₃)₂, RbNO₃, and Zn(NO₃)₂. Example suitable carbonates include CdCO₃, CoCO₃, CuCO₃, FeCO₃, PbCO₃, MnCO₃, Na₂CO₃ and ZnCO₃. Another means of incorporating oxygen can be through hydroxides. Example hydroxides include Cd(OH)₂, CsOH, Cu(OH)₂, KOH, LiOH, Mn(OH)₃, N₂OH, Ni(OH)₂, Pb(OH)₂, Pd(OH)₂, Pt(OH)₂, RbOH, Sn(OH)₂, Tl(OH)₃ and Zn(OH)₂. When an unstable oxide or hydroxide is ball-milled with a base metal alanate material, the oxide compound disassociates and the oxygen dopes into the metal alanate base material or is otherwise incorporated into the compound. One skilled in the art who has the benefit of this description will recognize additional suitable unstable solid oxides, mixed oxides or hydroxides.

Another method of doping a base material with oxygen is via an oxygen gas mixture. Oxygen may be introduced into a base metal alanate material through partial oxidation using oxygen gas in mixture with a non-reactive gas such as N₂ or Ar.

The invention has been described in an illustrative manner, and it is to be understood that the terminology used is intended to be in the nature of words of description rather than of limitation. Various modifications and variations of the given examples are possible in light of the above teachings. It is, therefore, to be understood that within the scope of the appended claims the invention may be practiced otherwise than as specifically described.

We claim:

1. A composition of matter comprising a metal alanate material doped with oxygen.

2. The composition of matter as recited in claim 1, wherein the metal alanate is NaAlH₄.

3. The composition of matter as recited in claim 1, wherein the metal alanate is M¹₍₁₋₂ₓ₎M²ₓ(AlH₄), wherein
M¹ is an alkali metal;
M² is an alkaline metal; and
0≦x≦9.

4. The composition of matter as recited in claim 1, wherein the metal alanate material is doped with at least one of an unstable metal oxide, a hydroxide, a nitrate or a carbonate.

5. The composition of matter as recited in claim 4, wherein the unstable metal oxide has −ΔG_{f}⁰>200 Kcal/mole.

6. The composition of matter as recited in claim 1, wherein the oxygen is from an oxygen gas mixture.

7. The composition of matter as recited in claim 1, wherein the metal alanate material is doped with between 0.5 mol % and 30 mol % oxygen.

8. A fuel cell device comprising:
a hydrogen storage portion comprising a metal alanate material doped with oxygen.

9. The fuel cell device as recited in claim 8, wherein the metal alanate material is NaAlH₄ .

10. The fuel cell device as recited in claim 8, wherein the metal alanate material is M¹₍₁₋₂ₓ₎M²ₓ (AlH₄), wherein
M¹ is an alkali metal;
M² is an alkaline metal; and
0≦x≦9.

11. The fuel cell device as recited in claim 8, wherein the metal alanate material is doped with at least one of an unstable metal oxide, a hydroxide, a nitrate or a carbonate.

12. The fuel cell device as recited in claim 11, wherein the unstable metal oxide has −ΔGₚ⁰>200 Kcal/mole.

13. The fuel cell device as recited in claim 8, wherein the oxygen source is an oxygen gas mixture.

14. The metal alanate material as recited in claim 8, wherein the metal alanate material is doped with between 0.5 mol % and 30 mol % oxygen.

15. A method of making a hydrogen storage material comprising:
doping a metal alanate material with oxygen.

16. The method of claim 15, wherein the metal alanate material comprises NaAlH₄.

17. The method of claim 15, wherein the metal alanate comprises M¹₍₁₋₂ₓ₎M²ₓ(AlH₄), and wherein
M¹ is an alkali metal;
M² is an alkaline metal; and
0≦x≦9.

18. The method of claim 15, including doping the metal alanate material with at least one of an unstable metal oxide, a hydroxide, a nitrate or a carbonate.

19. The method of claim 18, wherein the unstable metal oxide has −ΔG⁰_{f}>200 Kcal/mole.

20. The method of claim 15, including using an oxygen gas mixture.

21. The method of claim 15, including doping the metal alanate material with between 0.5 mol % and 30 mol % oxygen.
